(19) United States
(12) Patent Application Publication
(10) Pub. No.: US 2006/0172614 A1
(43) Pub. Date: Aug. 3, 2006

(54) Universal systems printed circuit blocks and method for interconnecting the same

(76) Inventor: Sang Henry Ta, Garden Grove, CA (US)

Correspondence Address: SANG HENRY TA, P.O. BOX 2423, COSTA MESA, CA, 92628, US

(21) Appl. No.: 11/051,393

(22) Filed: Feb. 3, 2005

(51) Int. Cl. H01R 4/48

(52) U.S. Cl. 439/835

(57) ABSTRACT

In Electronics, there exists three distinctive areas namely, discrete components or devices, circuits, and systems. A circuit is built from devices and a system is built from circuits. This invention aims at reducing the implementation of electronic systems down to just three steps namely, systems design, printed-circuit-board planar assembly, and systems test when-as a plurality of Universal Systems Printed-Circuit Blocks of pre-defined sizes is used. Each of said Universal Systems Printed-Circuit Blocks being usable and reusable for prototypes and production is built from a printed circuit board having thereon a functional circuit and a variety of circuit patterns and interconnection structures such that, any of said Blocks, when joined together with other Blocks on the same plane by standard connectors or electrically conductive compounds to form a systems board, can send and receive signals and voltages to and from any other Blocks.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

In Electronics, there exists three distinctive areas namely discrete components or devices, circuits, and systems. A circuit is built from devices and a system is built from functional circuits such as voltage divider, amplifiers, comparators, oscillators, logic gate arrays, power supply. This invention relates in general to printed circuit boards and in particular to printed circuit boards having thereon one of said functional circuits and a interconnection pattern of circuit conductors and plated-through holes, so that a plurality of said particular printed circuit board can be electrically connected and physically joined together on the same plane to form a system printed-circuit board. Therefore, this type of printed circuit boards is called systems printed-circuit building blocks or simply systems printed-circuit blocks because they really implement the functional blocks of a block diagram. Since each block performs a standard circuit function, it can be used and reused according to this invention in any electronic systems, hence, the title of Universal Systems Printed Circuit Blocks alternatively called as USPCB.

For the purpose of clarification and use, any person skilled in the art does know that a standard printed-circuit board shall have, as a minimum, edged copper conductors normally understood or called as printed wiring or circuit traces, edged copper pads normally called or understood as pads, and metallically plated-through apertures normally called or understood as plated-through holes. Therefore, terminologies of circuit trace(s), pad(s) and plated-through hole(s) are used hereinafter. Also, any person skilled in the art does know that a standard double-sided printed circuit board shall have as a minimum, a non-conductive substrate, a top copper-clad surface normally called or understood as upper surface or component side, and bottom copper-clad surface normally called or understood as lower surface or far-end side or circuit side. Therefore, terminologies of upper surface and lower surface are used hereinafter. Furthermore, any person skilled in the art does know that a standard multilayer printed-circuit board shall have as a minimum, an upper surface and lower surface, and two inner conductive layers being electrically isolated from each other by a non-conductive substrate. Said two inner conductive layers are normally used as a voltage plane and a ground plane. Therefore, terminologies of voltage plane and ground plane are used hereinafter.

It has been found from apparent applications and patent search that, heretofore, such a USPCB does not exist. U.S. Pat. No. 4,720,915 on Jan. 26, 1988 by Kennedy, and U.S. Pat. No. 4,325,780 on Apr. 20, 1982 by Schulz, and U.S. Pat. No. 6,226,862 on May 8, 2001 by Neuman, and U.S. Pat. No. 4,868,980 on Sep. 26, 1989 by Miller, and over 49 reference patents cited therewith all of them only relate to stand-alone printed circuit boards, i.e. printed circuit boards without a means for inter-board electrical connection on the same plane; additionally, U.S. Pat. No. 6,784,375 on Aug. 31, 2004 by Miyake, and U.S. Pat. No. 6,449,836 on Sep. 17, 2002 also by Miyake, and U.S. Pat. No. 4,950,527 on Aug. 21, 1990 by Yamada, and U.S. Pat. No. 3,832,603 on August 1974 by Cray all of them only relate to interconnecting printed circuit boards from different planes, such an interconnection method not only differs from the method used by this invention but also differs in the end use as described herein, furthermore, all of 48 reference patents being cited therewith have joined with the aforementioned 49 cited reference patents to also relate only to stand-alone printed circuit boards. Besides, none of said cited patents and reference patents mentions about a fully functional circuit being preinstalled on their related printed circuit board to play the role of a systems building block.

### SUMMARY OF THE INVENTION

In electronics engineering, electronic systems or products are implemented first by a circuit design then a systems design followed by discrete-components purchasings, breadboardings, tests, printed circuit board designs, printed circuit board fabrications, printed circuit board assembly, and systems tests. This invention aims at reducing said implementation of electronic systems down to just three steps, namely, systems design, printed circuit board assembly, and systems test when-as a plurality of Universal Systems Printed-Circuit Blocks or USPCB described hereinafter is used.

A person skilled in the art will immediately appreciate how much cost and time that this invention can save by implementing the design of a next electronic system not from discrete components but immediately with the planar assembly of a multi-piece system printed-circuit board, whereby, each piece is a pre-built reusable standard printed-circuit block which represents a functional block in the block diagram of said electronic system.

It is the primary objective of this invention to create a unique pattern of plated-through holes and circuit traces on a standard printed-circuit board in such a way that, a functional circuit when installed thereon can send and receive a plurality of electrical signals to and from other circuits when installed on other printed circuit boards of the same design and size or of multiple of said size.

It is also the primary objective of this invention to create a printed-circuit block by installing a functional circuit on the aforementioned printed-circuit board, in as much like a functional block of a block diagram.

It is also the primary objective of this invention to create a piecewise systems printed-circuit board wherein, each piece is a printed circuit block being joined together on the same plane by preferred means of low-cost edge connectors and/or electrically conductive jumping compound.

Finally, it is the primary objective of this invention to create a universal systems printed-circuit block by installing on the aforementioned systems printed-circuit board a so standard functional circuit that said block can be used and reused over and over again during any phases of a product cycle.

### BRIEF DESCRIPTION OF THE DRAWINGS

The novel features believed characteristic of the invention are set forth in the appended claims. The invention itself, however, as well as a preferred mode of use, will best be understood by reference to the following detailed description of an illustrative embodiment when read in conjunction with the accompanying drawings, wherein:

FIG. 1 depicts an enlarged plan view of the upper surface of a common USPCB which comprises a multilayer printed circuit board for surface-mounted components, a plurality of circuit components preinstalled thereon, and a pattern of circuit traces and plated through holes being arranged in such a way that the circuit on the USPCB can receive up to two input signals and one supply voltage, or one input signal and two supply voltages from a foregoing USPCB, and send one dual-line output signal and one supply voltage to a following USPCB;

FIG. 2 depicts an enlarged plan view of the lower surface of the USPCB in FIG. 1;

In order to have an overall picture of the board layout, circuit traces on the lower surface of the USPCB will be shown as dotted lines on all figure drawings hereinafter;

FIG. 3 depicts an enlarged view of a USPCB like the USPCB in FIG. 1, but two more pairs of plated-through holes columns have been added thereon for connection to additional input and output signals and supply voltages;

FIG. 4 depicts an enlarged view of a simple USPCB which only needs one input signal;

FIG. 5 depicts still another simple USPCB which still needs three inputs as the USPCB in FIG. 1 but does not send any signals to the output terminals, or sends out only one signal on just a single line;

FIG. 6 depicts a simpler USPCB. The systems circuit thereon needs only one input signal and one single-line output. This variation of the USPCB is often used for simple passive circuits;

FIG. 7 depicts a simplest USPCB on the planar assembly viewpoint. The functional circuit thereon needs one or more input signals but does not send out any signals and does not have any output trace terminals and plated through holes for electrically connecting to a next USPCB. This variation of the USPCB is often used at the end of a systems board;

FIG. 8 depicts an enlarged view of an interconnection circuit board used to interconnect the two adjacent rows of USPCB's;

FIG. 9 depicts another interconnection circuit board used to interconnect the two adjacent rows of USPCB's;

FIG. 10 depicts still another interconnection circuit board used to interconnect the two adjacent rows of USPCB's;

FIG. 11 depicts the block diagram of a simple electronic system;

FIG. 12 depicts a planar assembly of the USPCB's to implement the electronic system depicted in FIG. 11;

FIG. 13 is the same as FIG. 12, but the USPCB's therein are assembled vertically in rows using the double-high interconnection circuit board in FIG. 8; and

FIG. 14 depicts a part of a complex electronic system that makes more use of the plated through holes patterns on the USPCB to interconnect additional signals.

### DETAIL DESCRIPTION OF THE PREFERRED EMBODIMENT

Printed circuit boards used for the USPCB are of conventional multilayer type comprising as a minimum, a non-conductive substrate, an upper surface, a lower surface, a plurality of circuit traces, a plurality of circuit pads and a plurality of plated-through holes. For noise-sensitive circuits, two inner conductive layers are added, one of said two layers is used as a ground plane and the other as a voltage plane. Said plated through holes are used to interconnect circuit traces between said layers.

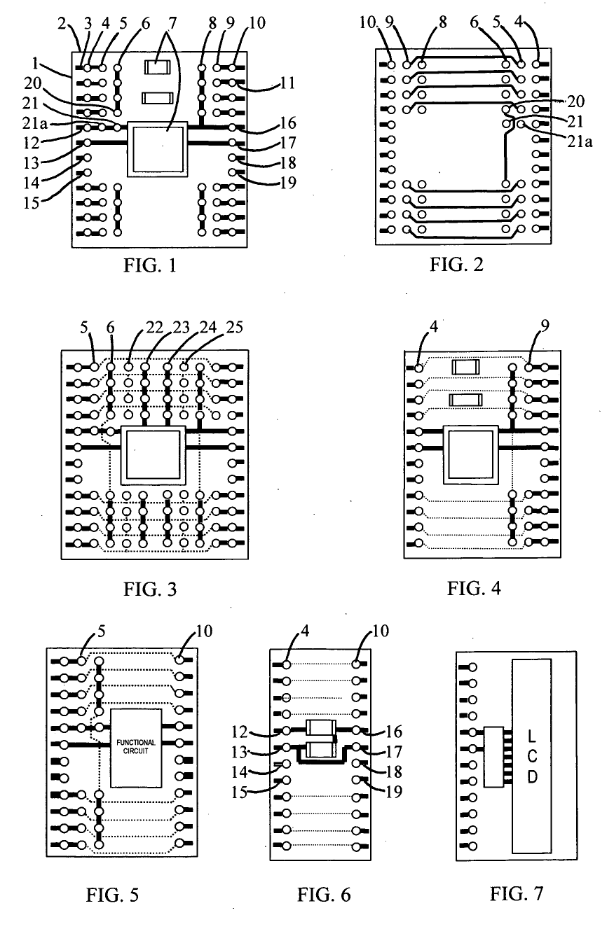

With reference now to the FIGURES and in particular with reference to FIG. 1, there is depicted an enlarged plan view of the upper surface of a most common USPCB. FIG. 2 depicts a plan view of the bottom surface of said USPCB. Referring to both figures, a USPCB has a height 1 of fixed length or a multiple of fixed length, a variable width 2, and a pattern of connection, wherein, trace terminal 3 is electrically connected to plated through holes 4, 5, 9, 10 and trace terminal 11; plated through hole 6 can be electrically connected to plated through hole 5 and plated through hole 8 can be electrically connected to plated through hole 9 by permanent or temporary pin jumpers or electrically conductive jumping compounds.

The aforementioned pattern of circuit traces, plated through holes and connection across the top edge of the USPCB are repeated in a plurality of rows all the way down to the bottom edge of said USPCB, except eight trace terminals 12 to 19. Trace terminals 12, 13, 14 and 15 are electrically connected each to an adjacent plated through hole on the right and are used for one signal input, one signal ground, one supply voltage, and one power ground. Trace terminals 16, 17, 18 and 19 are also electrically connected each to an adjacent plated through hole on the left and are used for one signal output, one signal ground, one supply voltage, and one power ground. All plated through holes under and in the same column with plated-through hole 6 including plated through hole 6 are electrically connected to each other and to the circuit on the USPCB. They are used to provide a second signal input by selectively and electrically connecting the column to one of the plated through holes under and in the same column with plated through hole 5 including plated through hole 5. All plated through holes under and in the same column with plated through hole 8 including plated through hole 8 are electrically connected to each other and to the signal output line of the USPCB, so that a same output can be sent to a plurality of USPCB's by selectively and electrically connecting the column to one or more plated through holes under and in the same column with plated through hole 9 including plated through hole 9. Plated through holes 14 and 18 are electrically connected to a first intermediate layer of the circuit board, which is used as a power ground plane. Plated through holes 15 and 19 are electrically connected to a second intermediate layer of the circuit board, which is used as a voltage plane. When a USPCB does not receive an electrical signal from the adjacent USPCB but from other USPCB's, plated through hole 20 will be jumped to plated through hole 21, or plated through hole 21a will be jumped to an upper adjacent plated through hole.

In order to have a overall image of the board layout, circuit traces on the lower surface of the USPCB are shown as dotted lines on all figure drawings thereafter.

Referring to FIG. 3, more signal inputs to a USPCB can be provided in the same manner as columns pair 5-6 by adding more pairs of plated-through-hole columns like the columns pair 22-23, thereby, each plated through hole under and in the same column with the plated through hole 22 including plated through hole 22 can be electrically connected to each plated through hole on the same row under and in the same column with plated through hole 23 including plated through hole 23. In the same way, more separate signal outputs from the USPCB are provided by adding more pairs of plated-through-hole columns like columns pair 24-25, thereby, each plated through hole in one column can be electrically connected to each plated through hole in another column on the same row, all plated through holes under and in the same column with the plated through hole 24 including plated through hole 25 are electrically connected to each other and to another separate output line of the USPCB. In general, all said pairs of plated-through-hole columns can be used interchangeably for both additional inputs and outputs regardless of signals or supply voltages.

Referring to FIGS. 1 and 4, signal inputs to a USPCB can be reduced to just one. In this configuration, all plated through holes under and in the same column with the plated through hole 5 including plated-through hole 5 and all plated through holes under and in the same column with the plated through hole 6 including plated through hole 6 do not exist. With this arrangement, the plated through hole 4 is electrically connected directly to the plated through hole 9, and so is each plated through hole under and in the same column with plated-through holes 4 and 9 and on the same row, except eight trace terminals and plated through holes 12 to 19 which are reserved for local connections.

Referring to FIGS. 1 and 5, a USPCB may still needs three inputs including voltage inputs, but the dual-line signal output 16 in FIG. 1 has been reduced to no output or just a single-line output as depicted in FIG. 5. In this configuration, all plated through holes under and in the same column with the plated through hole 8 including plated through hole 8 and all plated through holes under and in the same column with the plated-through hole 9 including plated through hole 9 do not exist. With this arrangement, the plated through hole 5 is electrically connected directly to the plated through hole 10, and so is each plated through hole under and in the same column with the plated through holes 5 and 10 and on the same row, except eight trace terminals and plated through holes 12 to 19 which are reserved for on-the-board connections.

Referring to FIGS. 5 and 6, the number of input lines to the USPCB in FIG. 5 can be reduced to just two including the voltage line. In this configuration all plated through holes under and in the same column with the plated through hole 5 including plated through hole 5 and all plated through holes under and in the same column with the plated through hole 6 including plated through hole 6 do not exist. With this arrangement, the plated through hole 4 is electrically connected directly to the plated through hole 10, and so is each plated through hole under and in the same column with plated through holes 4 and 10 on the same row.

FIG. 7 depicted another variation of the USPCB used for display device or edge connector installation, said USPCB does not send any signals to the output line. In this configuration, plated through holes 8, 9 and 10 in FIG. 1 and all other plated through holes under and in the same column with them do not exist. This variation of the USPCB has least plated through holes and can be narrowest in width.

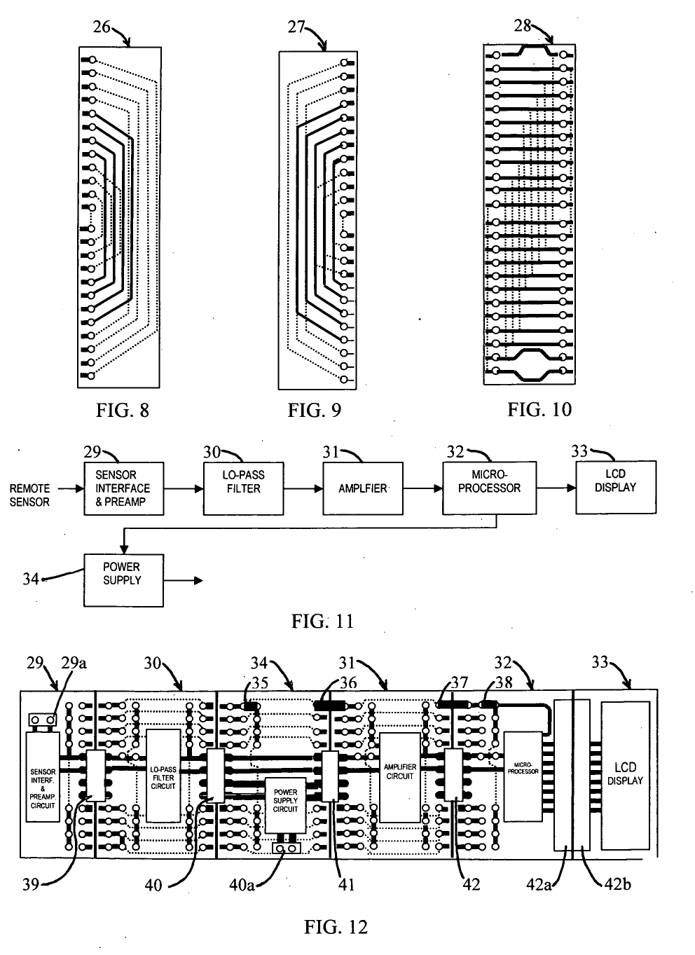

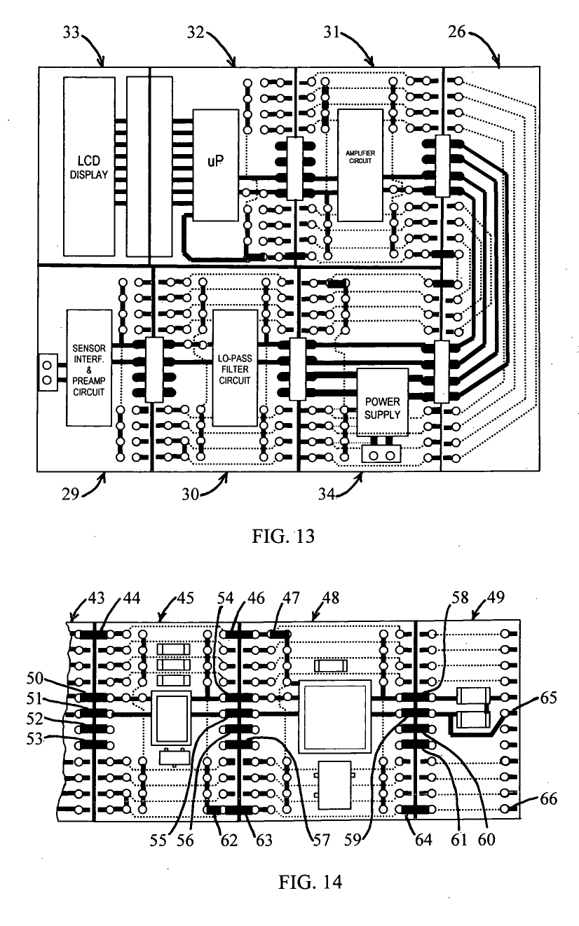

When a plurality of USPCB's have to be assembled in rows as depicted in FIG. 13, double-height interconnection printed circuit boards 26, 27, 28 depicted in FIGS. 8, 9, and 10 are used to provide a electrical continuation of the power line and electrical signals from one row to another. Each of said interconnection printed circuit boards can be considered as a USPCB because it is universal and is part of a systems board.

USPCB 26 depicted in FIG. 8 is used to electrically interconnect the output end of a USPCB row to the input end of a next USPCB row when the USPCB's are assembled from left to right. Consequently, USPCB 26 only needs one column of trace terminals and plated through holes on its left edge.

USPCB 27 depicted in FIG. 9 is used to electrically interconnect the output end of a USPCB row to the input end of a next USPCB row when the USPCB's are assembled from right to left. Consequently, USPCB 27 only needs one column of trace terminals and plated through holes on its right edge.

USPCB 28 depicted in FIG. 10 is used to electrically interconnect any two input ends or two output ends of two adjacent USPCB rows. Consequently, USPCB 28 has one column of trace terminals and plated-through holes on both of its right and left edges.

Normally, a designer starts a systems design with a block diagram as depicted in FIG. 11 for a simple electronic system. Block 29 interfaces with a remote sensor such as temperature, pressure . . . The designer selects said remote sensor and a USPCB which matches to the specification of each circuit block on said block diagram.

Next, the designer assembles said selected USPCB's as described hereunder.

FIG. 12 illustrates a linearly planar assembly of a plurality of USPCB's to implement the block diagram in FIG. 11. The USPCB's are electrically interconnected by joining the output edge of one block to the input edge of another block and using multi-pin connectors or electrically conductive jumping compounds. For this embodiment, both multi-pin connectors and electrically conductive jumping compounds are used. Multi-pin connectors are used to interconnect one signal line and one supply-voltage line between two adjacent USPCB's including one signal-ground line and one power-ground line, and electrically conductive jumping compounds are used to interconnect other signals coming from any USPCB's. Referring to both FIGS. 11 and 12, a 2-wire remote sensor is connected to an edge connector 29a on the USPCB 29, its output is sent to the interface circuit thereon. The preamplifier amplifies said sensor signal before sending it to a Lo-Pass-Filter USPCB 30 via a dual row 8-pin connector 39. Amplifier USPCB 31 receives said filtered signal from USPCB 30 via two dual row 8-pin connectors 40 and 41. Microprocessor USPCB 32 receives the amplified signal from USPCB 31 via a 4-pin connector 42. A microprocessor on USPCB 32 processes said amplified signal before sending it to a Display USPCB 33 via a female edge-connector 42a and a male edge-connector 42b. Finally, USPCB 33 displays said processed signal on a liquid-crystal-display device installed thereon. In order to minimize voltage drops across a power-supply line, a Power-Supply USPCB 34 is inserted between USPCB 30 and USPCB 31. USPCB 34 is connected to an external unregulated power-supply source via an edge connector 40a. Supply voltage and power ground coming out from the USPCB 34 are connected to all other USPCB's via two lower pins of said 4-pin connectors.

Said plurality of USPCB's in FIG. 12 can be assembled in rows as illustrated in FIG. 13 wherein, USPCB's 29, 30 and 34 are in the lower row and USPCB's 31, 32 and 33 are in the upper row. The USPCB 26 in FIG. 8 is used to electrically connect said lower row to said upper row.

Finally, the designer shall test and adjust the systems board just formed by said plurality of USPCB's for functioning and accurate specifications.

FIG. 14 depicted a part of a linearly planar assembly for a more complex system, which makes more use of the plated-through-hole and connection patterns on the USPCB. For this assembly, an electrically conductive jumping compound is used for all connections. USPCB 45 receives one signal and one supply voltage together with one signal ground and one power ground from USPCB 43 via jumpers 50,51,52,53. USPCB 48 receives two signals, one of said two signals and said supply voltage together with said signal ground and said power ground come from USPCB 45 via jumpers 54, 55, 56, 57; another of said two signals comes from USPCB 43 via jumpers 44, 46, 47. USPCB 49 receives also two signals, one of said two signals and said supply voltage together with said signal ground and said power ground come from USPCB 48 via jumpers 58, 59, 60, 61; another of said two signals comes from USPCB 45 via jumpers 62, 63, 64. Finally, USPCB 49 supplies two signals from output trace terminals 65 and 66.

During the prototype phase, said electrically conductive jumping compound shall be flexible and/or workable. For high-volume productions, a jumper application template shall be used and said jumping compound shall be made out of permanent adhesives.

The invention is claimed as follows:

1. To design and fabricate an industry-standard printed circuit board with a circuit pattern and interconnection structure comprising:
(a) a first column of n circuit trace terminals placed very close to the left edge of the board, where n is a variable number equal to or greater than zero;
(b) a second column of n circuit trace terminals placed very close to the right edge of the board and on the same rows with the circuit trace terminals in said first column;
(c) a third column of n plated through holes wherein, each plated through hole is placed next to the right of and in electrical contact with each circuit trace terminal on the same row in said first column;
(d) a fourth column of n plated through holes wherein, each plated through hole is placed next to the left of and in electrical contact with each circuit trace terminal on the same row in said second column;
(e) a group of n rows of circuit traces placed in between the plated through holes;
(f) a first group of circuit traces wherein, each circuit trace connects each circuit trace of said n rows of circuit traces to each of the adjacent plated through hole in said third column; and
(g) a second group of circuit traces wherein, each circuit trace connects each circuit trace of said n rows of circuit traces to each of the adjacent plated through hole in said fourth column and on the same row with the plated through hole in said third column;
(h) a fifth column of four circuit trace terminals placed everywhere and in the same column with said first column; and
(i) a sixth column of four circuit trace terminals placed everywhere and in the same column with said second column;
(j) a seventh column of four plated through holes wherein, each plated through hole is placed next to the right of and in electrical contact with each circuit trace terminal on the same row in said first column, and one plated through hole may be connected to a voltage plane and another plated through hole may be connected to a ground plane;
(k) an eight column of four plated through holes wherein, each plated through hole is placed next to the left of and in electrical contact with each circuit trace terminal on the same row in said second column, and one plated through hole may be connected to a voltage plane and another plated through hole may be connected to a ground plane; and
(l) at least one pad of any shape and size around each and all plated through holes.

2. The printed circuit board of claim 1 wherein, said circuit pattern and interconnection structure further comprising:
(a) at least one left pairs of columns of n plated-through-holes being placed each next to and on the same row with each of the plated through holes in said third column;
(b) a third group of circuit traces wherein, each circuit trace connects directly or indirectly each of the plated through holes in the left column of said left pair of columns to each of the plated through holes on the same row in said third column;
(c) a fourth group of circuit traces to interconnect every plated through holes to every other plated through holes in the same right column of said left pair of columns.
(d) a first row of two plated-through holes placed in the same row with a plated-through hole in said seventh column and under two columns of said left pair of columns or any other additional pairs of columns;
(e) a fifth group of circuit traces to connect two plated through holes in said first row to the plated through hole on the same row in said seventh column; and
(f) at least one pad of any shape and size around each and all the plated through holes.

3. The printed circuit board of claim 1 wherein, said circuit pattern and interconnection structure further comprising:
(a) at least one right pair of columns of n plated-through-holes being placed each next to and on the same row with each of the plated through holes in said fourth column;
(b) a third group of circuit traces wherein, each circuit trace connects directly or indirectly each of the plated through holes in the right column of said right pair of columns to each of the plated through holes on the same row in said fourth column;
(c) a fourth group of circuit traces to interconnect every plated through holes to every other plated through holes in the same left column of said right pair of columns;
(d) at least one pad of any shape and size around each and all plated through holes.

4. The printed circuit board of claim 2 wherein, said circuit pattern and interconnection structure further comprising:
(a) at least one right pair of columns of n plated-through-holes being placed each next to and on the same row with each of the plated through holes in said fourth column;
(b) a sixth group of circuit traces wherein, each circuit trace connects directly or indirectly each of the plated through holes in the right column of said right pair of columns to each of the plated through holes on the same row in said fourth column;
(c) a seventh group of circuit traces to interconnect every plated through holes to every other plated through holes in the same left column of each of said right pairs of columns; and
(d) at least one pad of any shape and size around each and all plated through holes.

5. The printed circuit board of claim 4 further comprising:
(a) an array of rows and columns of equally spaced through holes for mounting a plurality of discrete components;
(b) a ninth column of four plated through holes being placed next to and on the same rows with said seventh column;
(c) a tenth column of four plated through holes being placed next to and on the same rows with said eight column; and
(d) at least one pad of any shape and size around each and all plated through holes.

6. The printed circuit board of claim 1 with additions to become a universal systems printed circuit block therefore, said additions comprising:
(a) a printed circuit for at least one functional circuit;
(b) a second group of circuit traces connecting four plated-through holes in said seventh column to said printed circuit for input signal, signal ground, power voltage and power ground; and
(c) a third group of circuit traces connecting said printed circuit to four plated-through holes in said eight column for output signal, signal ground, power voltage and power ground.

7. The printed circuit board of claim 2 with additions to become a universal systems printed circuit block therefore, said additions comprising:
(a) a printed circuit for at least one functional circuit;
(b) a fifth group of circuit traces connecting four plated-through holes in said seventh column to said printed circuit for input signal, signal ground, power voltage and power ground; and
(c) a sixth group of circuit traces connecting said printed circuit to four plated-through holes in said eight column for output signal, signal ground, power voltage and power ground.

8. The printed circuit board of claim 3 with additions to become a universal systems printed circuit block therefore, said additions comprising:
(a) a printed circuit for at least one functional circuit;
(b) a fifth group of circuit traces connecting four plated-through holes in said seventh column to said printed circuit for input signal, signal ground, power voltage and power ground; and
(c) a sixth group of circuit traces connecting said printed circuit to four plated-through holes in said eight column for output signal, signal ground, power voltage and power ground.

9. The printed circuit board of claim 4 with additions to become a universal systems printed circuit block therefore, said additions comprising:
(a) a printed circuit for at least one functional circuit;
(b) a eight group of circuit traces connecting four plated-through holes in said seventh column to said printed circuit for input signal, signal ground, power voltage and power ground; and
(c) a ninth group of circuit traces connecting said printed circuit to four plated-through holes in said eight column for output signal, signal ground, power voltage and power ground.

10. The printed circuit board of claim 8 wherein, said circuit pattern and interconnection structure further comprising a seventh group of circuit traces to connect the bottom plated-through hole in the left column of the rightmost pair of said right pairs of columns to a plated through hole being used for output signal in said eight column.

11. The printed circuit board of claim 9 wherein, said circuit pattern and interconnection structure further comprising a tenth group of circuit traces to connect the bottom plated-through hole in the left column of the rightmost pair of said right pairs of columns to a plated through hole being used for output signal in said eight column.

12. A method for interconnecting a combination of at least two of the universal systems printed-circuit blocks of claims 5 to 11 to form a systems printed-circuit board, said method comprising the steps of:
(a) join as a first planar joint the right edge of a first block to the left edge of a second block;
(b) press a first dual-row electrical connector which has at least four contact leads on each row down to at least four plated-through holes in said eight column on the printed circuit board of said first block and four plated-through holes in said seventh column on the printed circuit board of said second block;
(c) join as a second planar joint the right edge of said second block to the left edge of a third block;
(d) press a second dual-row electrical connector which has at least four contact leads on each row down to at least four plated-through holes in said eight column on the printed circuit board of said second block and four plated-through holes in said seventh column on the printed circuit board of said third block;
(e) repeat steps (a) to (d) to next blocks until completed;
(f) on the same row, use a first jumper to electrically connect any two plated-through holes close to and at both sides of said first joint if not already connected by said first dual-row electrical connector and a second jumper to electrically connect two plated-through holes close to and at both sides of said second joint to allow an electrical signal or voltage to pass through said second block when required;
(g) repeat step (f) one or more times when more signals or voltages have to be passed through said second block when required;
(h) on the same row, use a third jumper to electrically connect any other two plated-through holes close to and at both sides of said first joint if not already connected by said first dual-row electrical connector and a fourth jumper to electrically connect two plated-through holes in one of said left pairs of columns on the printed circuit board of said second block to allow an additional electrical signal or voltage to be sent to said second block when required;
(i) repeat step (h) one or more times when more signals or voltages have to be sent to said second block when required;
(j) on the same row, use a fifth jumper to electrically connect any two plated-through holes near said second joint if not already connected by said second dual-row electrical connector and a sixth jumper to electrically connect two plated-through holes in said right pair of columns on the printed circuit board of said second block to allow a same signal to be sent on an additional output line or an additional signal to be sent from said second block to other blocks when required;
(k) repeat step (j) one or more times when more electrical signals to be sent from said second block to other blocks; and
(l) repeat steps (f) to (k) to other blocks of said systems printed-circuit board when required.

13. The method of claim 12 further comprising the steps of:
(a) join as a third planar joint the top edge of a end block to the top edge of another end block while keeping the right edge of said a end block in line with the left edge of said another end block;
(b) join as a fourth planar joint the left edge of a second interconnection printed-circuit board to both the right edge of said a end block and the left edge of said another end block; and
(c) press a dual-row electrical connector of multiple contacts down to all the plated-through holes located close to and on both sides of said fourth planar joint to implement a vertical or bidirectional blocks-row-to-blocks-row interconnection in such an order that, circuit trace terminals from the top right edge of said a end block are matched and electrically connected to one after another of circuit trace terminals from the top left edge of said another end block.

14. The method of claim 13 further comprising the steps of:
(a) join as a fifth planar joint the bottom edge of a end block to the bottom edge of another end block while keeping the right edge of said a end block in line with the left edge of said another end block;
(b) join as a sixth planar joint the right edge of a second interconnection printed-circuit board to both the right edge of said a end block and the left edge of said another end block; and
(c) press a dual-row electrical connector of multiple contacts down to all the plated-through holes located close to and on both sides of said sixth planar joint to implement a a vertical or bidirectional blocks-row-to-blocks-row interconnection in such an order that, circuit trace terminals from the top right edge of said a end block are matched and electrically connected to one after another of circuit trace terminals from top left edge of said another end block.

15. The method of claim 12 further comprising the steps of:
(a) join as a third planar joint on the same plane the top edge of a end block to the bottom edge of another end block while keeping the right edge of said a end block in line with the right edge of said another end block;
(b) join as a fourth planar joint the left edge of a first interconnection printed-circuit board which has to both the right edge of said a end block and the right edge of said another end block; and
(c) press a dual-row electrical connector of multiple contacts down to all the plated-through holes located close to and on both sides of said fourth planar joint to implement a vertical or unidirectional blocks-row-to-blocks-row interconnection in such an order that, trace terminals from the top right edge of said a end block are matched and electrically connected to one after another of trace terminals from the top right edge of said another end block.

16. The method of claim 12 wherein steps (b), (d), (f), (h) and (j) use an electrically conductive compound to coat all contact leads of said dual-row electrical connectors and jumpers before pressing said leads down the plated through holes.

17. The method of claim 13 wherein step (c) uses an electrically conductive compound to coat all contact leads of said connector before pressing said leads down the plated through holes.

18. The method of claim 14 wherein step (c) uses an electrically conductive compound to coat all contact leads of said dual-row electrical connector before pressing said leads down the plated through holes.

19. The method of claim 15 wherein step (c) uses an electrically conductive compound to coat all contact leads of said dual-row electrical connector before pressing said leads down the plated through holes.

20. The method of claim 12 wherein steps (b) and (d) use a pair of single-row male and female edge connectors to replace each of said dual-row electrical connectors.

21. The method of claim 13 wherein step (c) uses a pair of single-row male and female edge connectors to replace said dual-row electrical connector.

22. The method of claim 14 wherein steps (c) uses a pair of single-row male and female edge connectors to replace said dual-row electrical connector.

23. The method of claim 15 wherein steps (c) uses a pair of single-row male and female edge connectors to replace said dual-row electrical connector.

24. The method of claim 12 wherein steps (b) and (d) use an electrically conductive compound to replace said dual-row electrical connectors.

25. The method of claim 12 wherein steps (f), (h) and (j) use an electrically conductive compound to replace said jumpers.

26. The method of claim 12 wherein steps (b), (d), (f), (h) and (j) use an electrically conductive compound to replace all of said dual-row electrical connectors and jumpers.

27. The method of claim 13 wherein steps (c) uses an electrically conductive compound to replace said dual-row electrical connector.

28. The method of claim 14 wherein steps (c) uses an electrically conductive compound to replace said dual-row electrical connector.

29. The method of claim 15 wherein steps (c) uses an electrically conductive compound to replace said dual-row electrical connector.
